(19) United States
(12) Patent Application Publication
(10) Pub. No.: US 2005/0162709 A1
(43) Pub. Date: Jul. 28, 2005

(54) Media data recorder

(76) Inventor: Shu-Ya Chiang, Taichung (TW)

Correspondence Address: RABIN & CHAMPAGNE, P.C., Suite 500, 1101 14 Street, N.W., Washington, DC, 20005, US

(21) Appl. No.: 10/762,487

(22) Filed: Jan. 23, 2004

(51) Int. Cl. H04N 1/04

(52) U.S. Cl. 358/474

(57) ABSTRACT

A media data recorder applicable to flatbed scanning and automatic document feeding scanning includes a case, a media feeder, a data-fetching unit and a flatbed glass. The media feeder is mounted on upper side of the case for transferring the media (document). The data-fetching unit is mounted inside the case for scanning the content of the media. An opening is formed on top of the case for mounting the flatbed glass therein. When the media transferred by the media feeder along the media feeder path, the media smoothly moves on the flatbed glass and passes through the side of the opening. It prevents any paper jam problem because the side of the opening correspondent to the media feeder path is lower than the surface of the flatbed glass with a predetermined distance.

### BACKGROUND OF THE INVENTION

1. Field of the Invention

The invention generally relates to a media data recorder, such as printer, fax machine and scanner, and in particular relates to a media data recorder that can prevent from paper jam.

2. Related Art

Media data recoding devices, such as inkjet printers, laser printers, impact printers, plotters, scanners, multi-functional processors and copiers, are now popularly used by individuals and offices for scanning, printing, copying or facsimile. How to improve the printing quality or operational efficiency is the major concern of the manufacturers.

The conventional copy machines usually have roller mechanisms to transferring media during feeding, scanning, printing or ejecting. There are well-known flatbed and automatic document feeder (ADF) mechanisms used. Some related patents are disclosed, such as in U.S. Pat. Nos. 4,086,007; 5,010,364 and 6,307,621.

U.S. Pat. No. 4,086,007 provides two media-feeding mechanisms. One is feeding from a bottom cassette; the other is from an automatic document feeder at the top of the copier. The U.S. Pat. Nos. 5,010,364 and 6,307,621 also provide improvements of automatic document feeders on top of the machines.

Though the conventional mechanisms can provide multiple feeding functions, there are complicated gears for feeding and ejecting the media through two flat glass plates where flatbed scanning and automatic feeding scanning are made. During the automatic feeding, the media are easy to be jammed because of being bent in the transferring paths. Since the media are different in their characteristics and thickness, they are to be jammed during the scanning process even though there are assistant mechanisms, such as Mylar sheets, used to guide the media bending. The additional mechanisms also increase the manufacturing cost.

The conventional medium feeding mechanisms have the aforesaid drawbacks that are required to be solved.

### SUMMARY OF THE INVENTION

The object of the invention is to provide a media data recorder, such as a copier, a fax machine or a multi-function processor, which can prevent from media jam during automatic feeding process.

A media data recorder according to the invention includes a case, a media feeder, a data-fetching unit and a flatbed glass. The media feeder includes a plurality of rollers for transferring the media (document). The data-fetching unit is mounted under the media feeder for scanning the content of the media. An opening is formed on top of the case for mounting the flatbed glass therein. In order to prevent paper jam happening as that usually occurs in conventional machines that even use Mylar sheet mechanisms, a side of the opening in the invention correspondent to the media feeder path is lower than the surface of the flatbed glass with a predetermined distance. When the media transferred by the feeder along the media feeder path, the media smoothly moves on the flatbed glass and pass through the side of the opening. It prevents any paper jam problem because the side of the opening correspondent to the media feeder path is lower than the surface of the flatbed glass with a predetermined distance.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is an overall view of a media data recorder of the invention;

FIG. 2 is a partial enlarged view of the invention showing a side of an opening;

FIG. 3 is an enlarged view of a media feeder in the invention; and

FIGS. 4 to 7 are sequential functional views of a media data recorder of the invention.

### DETAILED DESCRIPTION OF THE INVENTION

A media data recorder according to the invention is applicable to scanning devices of both flatbed scanning and automatic document feeding scanning, and especially can prevent paperjam during the document feeding.

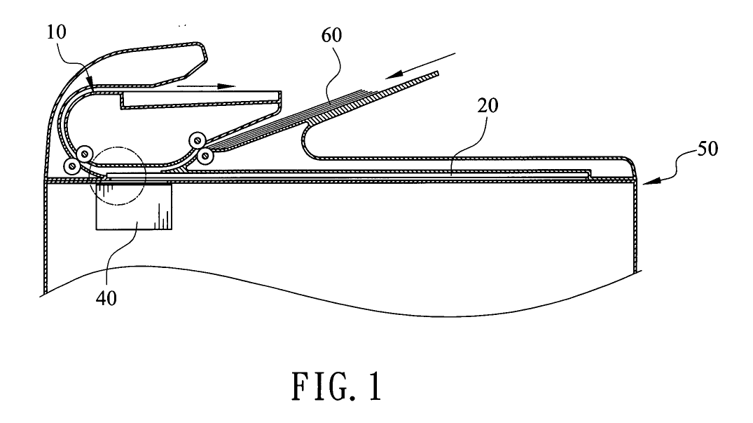

As shown in FIG. 1, a media data recorder of the invention mainly includes a case 50, a media feeder 10, a data-fetching unit 40 and a flatbed glass 20. The media data recorder can be a printer, a fax machine, a scanner, a multiple function processor or a copier, etc which operates in either a flatbed scanning or an automatic document feeding mode. When being operated in flatbed scanning, a user places a document on top of the flatbed glass 20 for the data-fetching unit (such as charge couple device, CCD) 40 to move and scan. When being operated in the automatic document feeding mode, the media feeder 10 transfers the media (document) 60 passing through the data-fetching unit 40 for scanning the content of the media 60. Conventional media data recorders easily cause paper jam during the document feeding even some Mylar sheet assistant mechanisms are used.

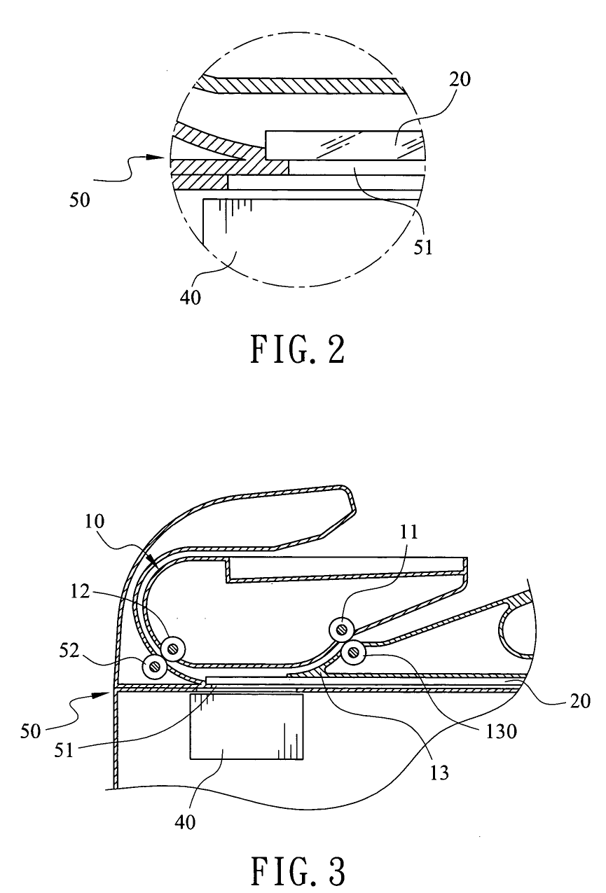

FIGS. 1 and 2, the media data recorder of the invention includes a case 50 having a containing space, and a media feeder 10 formed on upper side of the case 50 for automatic feeding of media 60. A data-fetching unit 40 is mounted inside the containing space of the case 50 for scanning the media 60. A flatbed glass 20 is mounted on top of the data-fetching unit 40 and under the media feeder 10 for the media 60 passing thereon and preventing dust getting into the case 50. There is an opening 51 formed on the case 50 for mounting the flatbed glass 20. In order to prevent paper jam happening as that usually occurs in conventional machines, a side of the opening 51 corresponding to the feeding path of the media feeder 10 is lower than the surface of the flatbed glass 20 with a predetermined distance. When the media 10 being transferred by the feeder along the media feeder path, the media 60 smoothly moves on the flatbed glass 20 and pass through the side of the opening 51. It prevents any paper jam problem because the side of the opening 51 corresponding to the media feeder path is lower than the surface of the flatbed glass 20 with a predetermined distance.

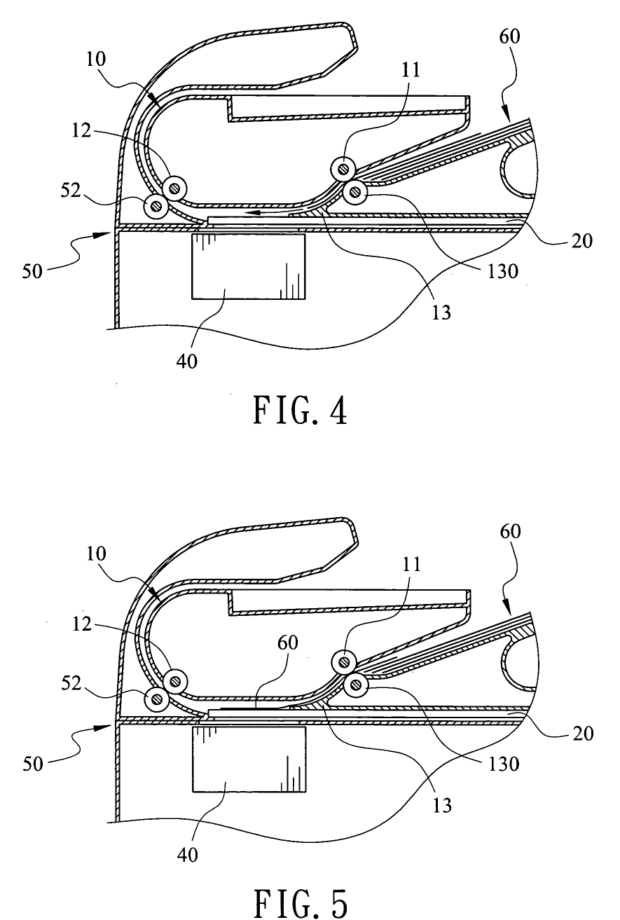

Please refer to FIGS. 3 to 7, sectional view and sequential functional views of the invention. The media feeder 10 includes a feeding roller 11 and an ejecting roller 12. A guide 13 is formed near the feeding roller 11. A first auxiliary roller 130 is mounted on the case 50 and corresponding to the feeding roller 11. A second auxiliary roller 52 is mounted on the case 50 and corresponding to the ejecting roller 12. The feeding roller 11, ejecting roller 12 and the first and second auxiliary rollers 130, 52 are all covered with a rubber layer for increasing friction to the media 60. The guide 13 is curvy and correspondent to the feeding roller 11 so as to transfer the media 60 fluently. The document-ejecting path formed on the case 50 is also curvy. The media feeder 10 further includes a motor (not shown in the drawing) for driving the feeding roller 11 and the ejecting roller 12.

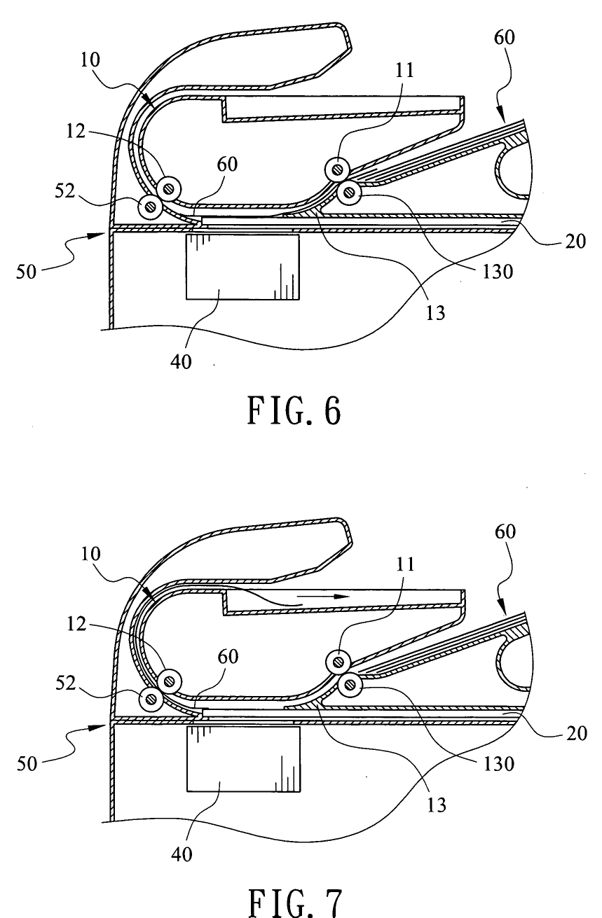

As shown in FIG. 4, the feeding roller 11 and the first auxiliary wheel 130 grasp the media 60 feeding from the right side and moving through the guide 13. Then, in FIG. 5, the feeding roller 11 continues rotation and pushes the media 60 further leftwards to pass through the data-fetching unit 40 so as to get the content on the media 60. As shown in FIG. 6, the media 60 touches one side of the case 50. In prior arts or conventional products, the case 50 and the flatbed glass 20 usually have an extrusion between the case and the class that easily cause paper jam. While in the invention, the side of the opening 51 corresponding to the media feeder path is lower than the surface of the flatbed glass 20 with a predetermined distance. Therefore, the media 60 can pass smoothly through the feeder path. Finally, as shown in FIG. 7, the media 60 are ejected by the ejecting roller 12 and the second auxiliary roller 52.

In conclusion, the media data recorder of the invention at least has the following advantages:

1) Preventing Paper Jam

The guide, the media feed path and the flatbed glass are in suitable relative positions to make the media move smoothly.

2) Lowering the Cost

In comparison with conventional media data recorders that use two glasses and complicated mechanisms, the invention uses only one flatbed glass for both flatbed scanning and automatic document feeding scanning. The construction and assembly process are therefore simple and cost less.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A media data recorder capable of transferring media for flatbed scanning and automatic document feeding scanning, comprising:
a case having a containing space;
a media feeder, mounted on upper side of said case for transferring said media;
a data-fetching unit, mounted inside said containing space of said case for scanning said media; and
a flatbed glass, mounted on top of said data-fetching unit; an opening formed on said case for mounting said flatbed glass; a side of said opening corresponding to feeding path of said media feeder is lower than surface of said flatbed glass with a predetermined distance so that when said media transferred by said feeder along said media feeder path, said media smoothly moves on said flatbed glass and passes through said side of said opening.

2. The media data recorder according to claim 1 wherein said media feeder comprises a feeding roller for feeding said media.

3. The media data recorder according to claim 2 wherein said feeding roller is covered with a rubber layer for a higher friction to said media.

4. The media data recorder according to claim 2 wherein one side of said media feeder comprises a guide adjacent to said feeding roller for guiding said media moving.

5. The media data recorder according to claim 4 wherein said guide adjacent to said feeding roller is a curvy path.

6. The media data recorder according to claim 4 wherein the guide comprises a first auxiliary roller is correspondent to said feeding roller for feeding said media.

7. The media data recorder according to claim 6 wherein said first auxiliary roller is covered with a rubber layer for a higher friction to said media.

8. The media data recorder according to claim 1 wherein said media feeder comprises an ejecting roller corresponding to the feeding roller for transferring said media.

9. The media data recorder according to claim 8 wherein said ejecting roller is covered with a rubber layer for a higher friction to said media.

10. The media data recorder according to claim 8 wherein the case comprises a second auxiliary roller corresponding to said ejecting roller for ejecting said media.

11. The media data recorder according to claim 10 wherein said second auxiliary roller is covered with a rubber layer for a higher friction to said media.

12. The media data recorder according to claim 8 wherein said case is formed with a curvy path adjacent to said ejecting roller.

13. The media data recorder according to claim 1 wherein said media feeder comprises a motor for driving said media feeder.
